(19) United States
(12) Patent Application Publication
(10) Pub. No.: US 2014/0019781 A1
(43) Pub. Date: Jan. 16, 2014

(54) SYSTEM FOR PROTECTING POWER SUPPLY CIRCUIT OF CENTRAL PROCESSING UNIT

(71) Applicant: JI-CHAO LI, Shenzhen City (CN)

(72) Inventor: JI-CHAO LI, Shenzhen City (CN)

(73) Assignees: HON HAI PRECISION INDUSTRY CO., LTD., Tu-Cheng (TW); HONG FU JIN PRECISION INDUSTRY (Shenzhen) CO., LTD, Shenzhen City (CN)

(21) Appl. No.: 13/592,426

(22) Filed: Aug. 23, 2012

(30) Foreign Application Priority Data
Jul. 16, 2012 (CN) 201210244950X

(51) Int. Cl. G06F 1/26

(52) U.S. Cl. 713/300

(57) ABSTRACT

A system includes a power supply unit, a central processing unit (CPU) power controller, a detecting circuit, an inductor, a thermal resistor, first and second field effect transistors (FETs), and first to third capacitors. The CPU power controller detects a voltage of the thermal resistor and compares the detected voltage with first and second preset values. If the detected voltage is greater than the first preset value and less than the second preset value, the CPU power controller outputs a first control signal to a base management controller (BMC) chip for signaling the BMC chip to control the fan to increase a speed. If the detected voltage is greater than the second preset value, the CPU controller outputs a second control signal to the CPU for signaling the CPU to regulate a working frequency or reduce a number of loads.

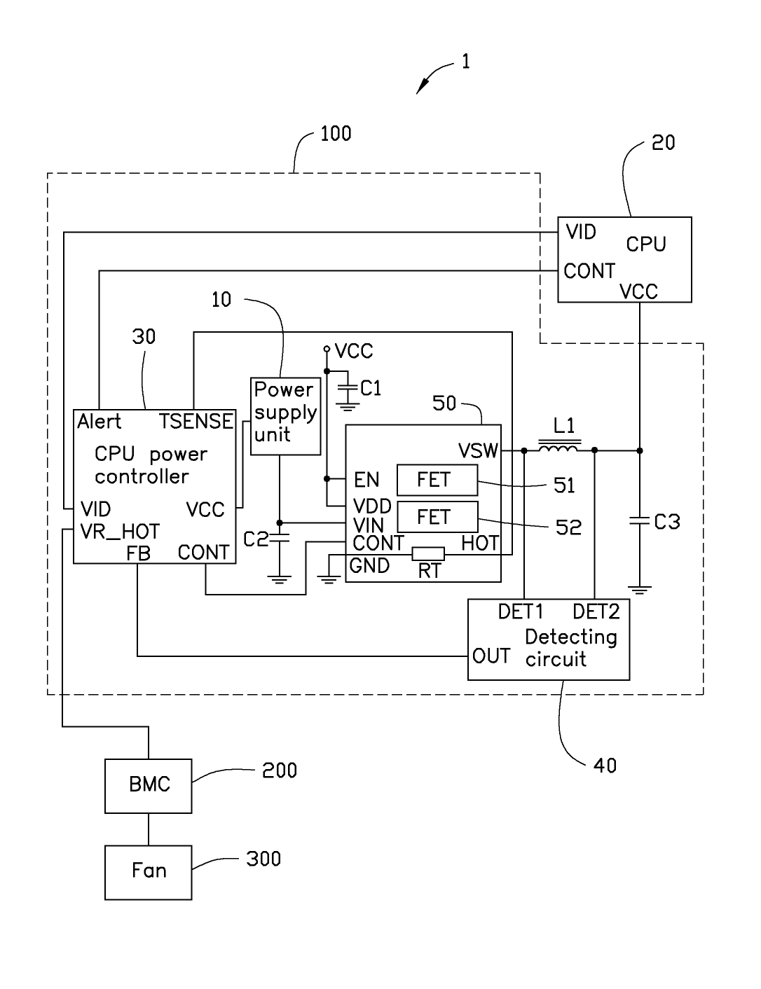

### BACKGROUND

1. Technical Field

The present disclosure relates to protection systems, and particularly to a system for protecting a power supply circuit of a central processing unit (CPU).

2. Description of Related Art

Like other electronic components on a motherboard, the CPU must work with an operation voltage which is supplied by the motherboard. Because deferent kinds of CPUs have different operation voltages, a CPU power supply circuit is set on the motherboard for supplying an operation voltage suitable for the CPU. Conventionally, the CPU power supply circuit regulates the output voltage of the power supply unit to a suitable voltage of the CPU by controlling two field effect transistors (FETs), which are included in the CPU power supply circuit, to be turned on or off. However, when the computer is operating, surrounding temperature of the FETs increases due to thermal affect of current. This high temperature may damage the FETs, thus, the CPU power supply circuit cannot regulate the voltage of the CPU correctly. Therefore, the CPU or even the motherboard may be damaged.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments.

The figure is a circuit diagram of a system for protecting a power supply circuit of a central processing unit in accordance with an exemplary embodiment of the present disclosure.

### DETAILED DESCRIPTION

The disclosure, including the drawing, is illustrated by way of example and not by way of limitation. References to “an” or “one” embodiment in this disclosure are not necessarily to the same embodiment, and such references mean at least one.

Referring to the figure, a system 100 is arranged on a motherboard 1 in the embodiment. The system 100 is used for protecting a power supply circuit of a central processing unit (CPU) 20 of the motherboard 1. The system 100 includes a power supply unit 10, a CPU power controller 30, a detecting circuit 40, an electronic element 50, an inductor L1, and capacitors C1-C3. The electronic element 50 includes two field effect transistors (FETs) 51 and 52, and a thermal resistor RT packaged with the FETs 51 and 52. The power supply unit 10 converts an external alternating current (AC) power to a direct current (DC) power and provides the DC power to all modules of the motherboard 1. The CPU power controller 30 stores a first preset value and a second preset value. In one embodiment, resistance of the thermal resistor RT increases when surrounding temperature increases. The detecting circuit 40 detects a voltage of the inductor L1. The detecting circuit 40 is well known in the art and for reason of simplicity will not be described here.

A voltage setting pin VID of the CPU power controller 30 is connected to a voltage setting pin VID of the CPU 20, to receive a voltage from the voltage setting pin VID of the CPU 20 and convert the voltage to a rated voltage of the CPU 20. A voltage pin VCC of the CPU power controller 30 is connected to the power supply unit 10, to receive a voltage from the power supply unit 10. A feedback pin FB of the CPU power controller 30 is connected to an output pin OUT of the detecting circuit 40. A detecting pin TSENSE of the CPU power controller 30 is connected to a first terminal of the thermal resistor RT through a detecting pin HOT of the electronic element 50. A second terminal of the thermal resistor RT is grounded through a ground pin GND of the electronic element 50. A control pin Alert of the CPU power controller 30 is connected to a control pin CONT of the CPU 20. A control pin VR_HOT of the CPU power controller 30 is connected to a base management controller (BMC) chip 200 of the motherboard 1. The BMC chip 200 is connected to a fan 300 of the motherboard 1. A control pin CONT of the CPU power controller 30 is connected to a control pin CONT of the electronic element 50. An input pin VIN of the electronic element 50 is connected to the power supply unit 10 and also grounded through the capacitor C2. Voltage pins VDD and EN of the electronic element 50 are connected to a power source VCC and also grounded through the capacitor C1. An output pin VSW of the electronic element 50 is connected to a voltage pin VCC of the CPU 20 through the inductor L1. The capacitor C3 is connected between the voltage pin VCC of the CPU 20 and ground. Detecting pins DET1 and DET2 of the detecting circuit 40 are respectively connected to two ends of the inductor L1.

In use, when the motherboard 1 is powered on, the CPU power controller 30 receives a voltage from the voltage setting pin VID of the CPU 20 and converts the voltage to the rated voltage of the CPU 20. The CPU power controller 30 controls the FET 51 to turn on and controls the FET 52 to turn off through the control pins CONT. The power supply unit 10 provides an output voltage to the CPU 20 through the electronic element 50 and the inductor L1. The detecting circuit 40 detects a voltage of the inductor L1 through the detecting pins DET1 and DET2 and outputs the detected voltage to the CPU power controller 30. The CPU power controller 30 compares the detected voltage with the rated voltage of the CPU 20. If the detected voltage is greater than the rated voltage, the CPU power controller 30 controls the FET 51 to turn off and controls the FET 52 to turn on. The inductor L1 discharges for reducing the voltage output to the voltage pin VCC of the CPU 20. If the detected voltage is less than the rated voltage, the CPU power controller 30 controls the FET 51 to turn on and controls the FET 52 to turn off. The power supply 10 charges the inductor L1 for increasing a voltage output to the voltage pin VCC of the CPU 20. Thus, the CPU 20 is always operating on a correct voltage.

When the operation time of the motherboard 1 increases, the surrounding temperature of the motherboard 1 increases due to thermal affect of current. The temperature of the FETs 51 and 52 increases. Because the resistance of the thermal resistor RT increases when surrounding temperature increases. A voltage of the thermal resistor RT is detected by the CPU power controller 30 through the detecting pin TSENSE after the CPU power controller 30 outputs a voltage to the thermal resistor RT. The CPU power controller 30 compares the detected voltage of the thermal resistor RT with the first and second preset values. If the detected voltage of the thermal resistor is greater than the first preset value and less than the second preset value, the CPU power controller 30 outputs a first control signal to the BMC chip 200 through the control pin VR_HOT, to signal the BMC chip 200 to control the fan 300 to increase a speed for dissipating more heat for the FETs 51 and 52. If the detected voltage is greater than the second value, the CPU power controller 30 outputs a second control signal to the CPU 20 through the control pin Alert, to signal the CPU 20 to regulate a working frequency or reduce a number of loads for reducing thermal affect to the FETs 51 and 52. Therefore, the system 100 can prevent the FETs 51 and 52 from being damaged due to the thermal affect of current, and thus the CPU 20 always operates on a correct voltage.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A system for protecting a power supply circuit of a center processing unit (CPU) of a motherboard, the system comprising:
a power supply unit;
an inductor;
an electronic element comprising a thermal resistor and first and second field effect transistors (FETs), wherein two voltage pins of the electronic element are connected to a power source, an input pin of the electronic element is connected to the power supply unit, an output pin of the electronic element is connected to a voltage pin of the CPU through the inductor;
a first capacitor connected between the voltage pins of the electronic element and ground;
a second capacitor connected between the input pin of the electronic element and ground;
a third capacitor connected between the voltage pin of the CPU and ground;
a detecting circuit comprising first and second detecting pins connected to two ends of the inductor, and an output pin; and
a CPU power controller storing a first preset value and a second preset value, the CPU power controller comprising:
a voltage setting pin connected to a voltage setting pin of the CPU, to receive a voltage from the CPU and convert the voltage from the CPU to a rated voltage of the CPU;
a voltage pin connected to the power supply unit, to receive a voltage;
a feedback pin connected to the output pin of the detecting circuit;
a detecting pin connected to one of the ends of the thermal resistor through a detecting pin of the electronic element;
a first control pin connected to a control pin of the CPU;
a second control pin connected to a base management controller (BMC) chip which is connected to a fan of the motherboard; and
a third control pin connected to a control pin of the electronic element;
wherein when the motherboard is powered on, the CPU power controller controls the first FET to turn on and controls the second FET to turn off through the third control pin, the power supply unit provides a voltage to the CPU through the inductor, the CPU power controller detects a voltage of the thermal resistor through the detecting pin and compares the detected voltage of the thermal resistor with the first and second preset values, upon the condition that the detected voltage of the thermal resistor is greater than the first preset value and less than the second preset value, the CPU power controller outputs a first control signal to the BMC chip through the second control pin for signaling the BMC chip to control the fan to increase speed, upon the condition that the detected voltage of the thermal resistor is greater than the second preset value, the CPU controller outputs a second control signal to the CPU through the first control pin for signaling the CPU to regulate a working frequency or reduce a number of loads, the detecting circuit detects a voltage of the inductor through the first and second detecting pins and outputs the detected voltage of the inductor to the CPU power controller, the CPU power controller compares the detected voltage of the inductor with the rated voltage of the CPU, upon the condition that the detected voltage of the inductor is greater than the rated voltage of the CPU, the CPU power controller controls the first FET to turn off and controls the second FET to turn on, the inductor discharges for reducing the voltage of the voltage pin of the CPU, upon the condition that the detected voltage of the inductor is less than the rated voltage of the CPU, the CPU power controller controls the first FET to turn on and controls the second FET to turn off, the power supply unit charges the inductor for increasing the voltage of the voltage pin of the CPU.

2. The system of claim 1, wherein resistance of the thermal resistor increases when the surrounding temperature increases.

3. The system of claim 1, wherein the thermal resistor is packaged with the first and second FETs.
